(19) United States
(12) Patent Application Publication
(10) Pub. No.: US 2005/0259616 A1
(43) Pub. Date: Nov. 24, 2005

(54) Data transport in UMTS

(76) Inventors: Tamas Major, Dusseldorf (DE); Kari Veijalainen, Vantaa (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/924,203

(22) Filed: Aug. 24, 2004

(30) Foreign Application Priority Data
May 19, 2004 (FI) 20045182

(51) Int. Cl. H04L 12/56

(52) U.S. Cl. 370/329

(57) ABSTRACT

Data transport methods, a radio network controller, a network element, and a computer program are provided. The method includes: forming a transport channel data stream from at least a portion of a logical channel data stream; forming a high-speed downlink packet access data stream from at least a portion of a logical channel data stream; and multiplexing at least a portion of the transport channel data stream and at least a portion of the high-speed downlink packet access data stream into a virtual channel.

### FIELD

The invention relates to data transport methods, a radio network controller, a network element, and a computer program.

### BACKGROUND

An HSDPA (High-Speed Downlink Packet Access) system provides a packet-based downlink data service in the UMTS (Universal Mobile Telecommunications System) with a typical data transmission capacity from a few megabits per second to more than ten megabits per second.

In the implementation of the HSDPA system, a MAC (Medium Access Control) layer of a UMTS terrestrial radio access network (UT-RAN) has been distributed amongst various network elements, such as radio network controllers (RNC) and nodes B.

During HSDPA connection establishment, a data transport link between network elements is established and a fixed data transfer capacity is typically reserved for each HSDPA connection. However, an actual data transfer capacity requirement of the HSDPA connections is typically not yet known at the instant of a data transfer capacity reservation and a reserved data transfer capacity may not meet the actual data transfer capacity requirement. As a result, the data transfer capacity of the data transport link may be overloaded or a portion of the data transfer capacity may be wasted. Therefore, it is desirable to consider improvements in data transport between network elements in a UMTS network.

### BRIEF DESCRIPTION OF THE INVENTION

An object of the invention is to provide improved methods, a radio network controller, a network element, and a computer program for transporting data in a UMTS network.

According to a first aspect of the invention, there is provided a data transport method for a UMTS network, the method comprising: forming a transport channel data stream from at least a portion of a logical channel data stream; forming a high-speed downlink packet access data stream from at least a portion of a logical channel data stream; and multiplexing at least a portion of the transport channel data stream and at least a portion of the high-speed downlink packet access data stream into a virtual channel.

According to a second aspect of the invention, there is provided a data transport method for a UMTS network, the method comprising: forming at least one transport channel asynchronous transfer mode adaptation layer 2 connection; forming at least one high-speed downlink packet access asynchronous transfer mode adaptation layer 2 connection; and multiplexing the at least one high-speed downlink packet access asynchronous transfer mode adaptation layer 2 connection and the at least one transport channel asynchronous transfer mode adaptation layer 2 connection into a virtual channel connection.

According to a third aspect of the invention, there is provided a network element of a UMTS network, the network element comprising: first forming means for forming a transport channel data stream from at least a portion of a logical channel data stream; second forming means for forming a high-speed downlink packet access data stream from at least a portion of a logical channel data stream; and multiplexing means for multiplexing the transport channel data stream and the high-speed downlink packet access data stream into a virtual channel.

According to a fourth aspect of the invention, there is provided a radio network controller of a UMTS network, the radio network controller comprising: first forming means for forming at least one transport channel asynchronous transfer mode adaptation layer 2 connection; second forming means for forming at least one high-speed downlink packet access asynchronous transfer mode adaptation layer 2 connection; and multiplexing means for multiplexing the at least one high-speed downlink packet access asynchronous transfer mode adaptation layer 2 connection and the at least one transport channel asynchronous transfer mode adaptation layer 2 connection into a virtual channel connection.

According to yet another aspect of the invention, there is provided a computer program embodied on a computer readable medium, for executing a computer process for data transport in a UMTS network, the computer process including steps, the steps comprising: forming at least one transport channel asynchronous transfer mode adaptation layer 2 connection; forming at least one high-speed downlink packet access asynchronous transfer mode adaptation layer 2 connection; and multiplexing the at least one high-speed downlink packet access asynchronous transfer mode adaptation layer 2 connection and the at least one transport channel asynchronous transfer mode adaptation layer 2 connection into a virtual channel connection.

The invention provides several advantages. The multiplexing of the transport channel data and the HSDPA data into a common virtual channel enables an efficient use of the transport capacity of the virtual channel, thus improving the data transport capacity between the network elements and increasing the performance of the HSDPA system.

### LIST OF DRAWINGS

In the following, the invention will be described in greater detail with reference to the embodiments and the accompanying drawings, in which

FIG. 1 shows an example of the structure of a UMTS telecommunications system;

FIG. 2 shows an example of the structure of a radio network controller;

FIG. 3 illustrates an example of an embodiment of transport capacity distribution between different data;

FIG. 4 shows a first example of a methodology according to embodiments of the invention, and

FIG. 5 shows a second example of a methodology according to embodiments of the invention.

### DESCRIPTION OF EMBODIMENTS

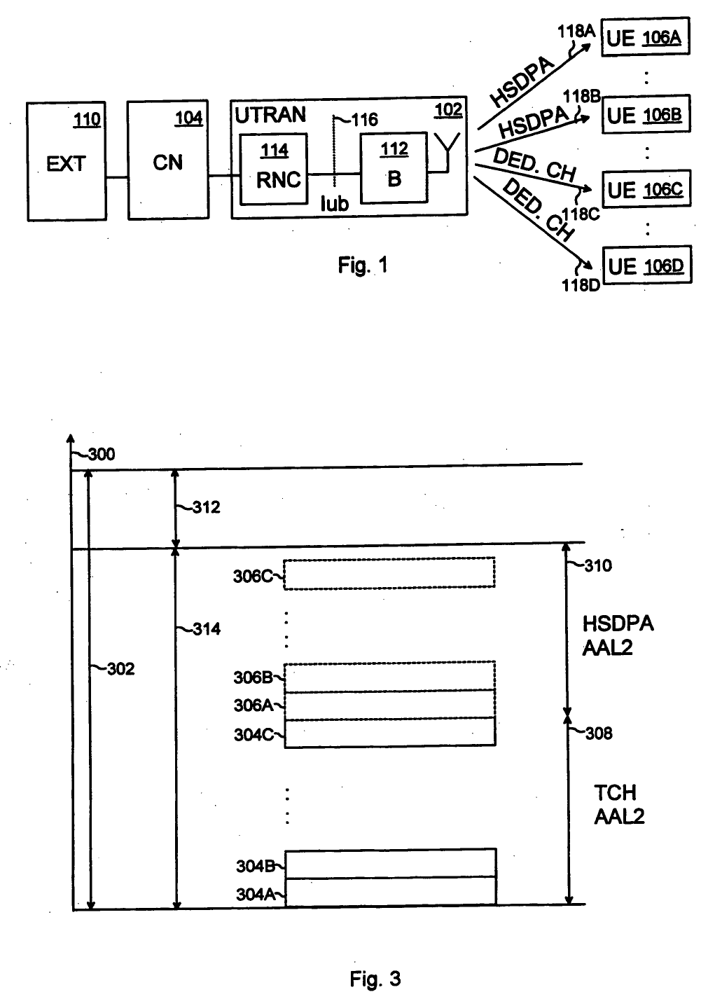

With reference to FIG. 1, a universal mobile telecommunications system (UMTS) includes a UMTS terrestrial radio access network (UTRAN) 102, a core network (CN) 104 connected to the UTRAN 102, and user equipment sets (UE) 106A to 106D connectable to the UTRAN 102 over a radio interface.

The UTRAN 102 provides a radio interface between the terrestrial part of the UMTS and the user equipment sets 106A to 106D. The UTRAN 102 includes at least one node B 112, which implements physical channels, such as HSDPA (High-Speed Downlink Packet Access) downlink channels 118A, 118B and dedicated downlink channels 118C, 118D.

The HSDPA downlink channels 118A, 118B include, for example, an HS-PDSCH (High-Speed Physical Downlink Shared Channel) for downlink packet transfer and an HS-SCCH (High-Speed Physical Downlink Shared Control Channel), which serves as a downlink signalling channel parallel to the HS-PDSCH. The HS-PDSCH may provide a plurality of user-specific HSDPA connections to the user equipment sets 106A, 106B.

The dedicated downlink channels 118C, 118D may include, for example, a dedicated physical data channel (DPDCH) and a dedicated physical control channel (DPCCH). The DPDCH carries dedicated user traffic between the node B 112 and user equipment set 106B, 106D. The DPDCH may carry a plurality of user-specific connections simultaneously.

The UTRAN 102 further includes at least one radio network controller (RNC) 114 connected to the node B 112 over a transport interface (Iub) 116. The RNC 114 serves as a switching and controlling element of the UTRAN 102. The radio network controller 114 typically includes a digital signal processor and software for executing computer processes stored on a computer readable medium. Furthermore, the radio network controller 114 typically includes connecting means for communicating electric signals with other network elements, such as radio network controllers and/or nodes B.

The core network 104 provides a combination of exchanges and transmission equipment, which together form a basis for UMTS telecommunications network services. The core network 104 may include a packet-switched domain for providing packet-switched telecommunications services for the user equipment sets 106A, 106B. The core network 104 may include a circuit-switched domain for providing circuit-switched telecommunications services for the user equipment sets 106C, 106D.

The core network 104 may be connected to external networks (EXT) 110, such as the Internet and/or a Public Switched Telephone Network (PSTN).

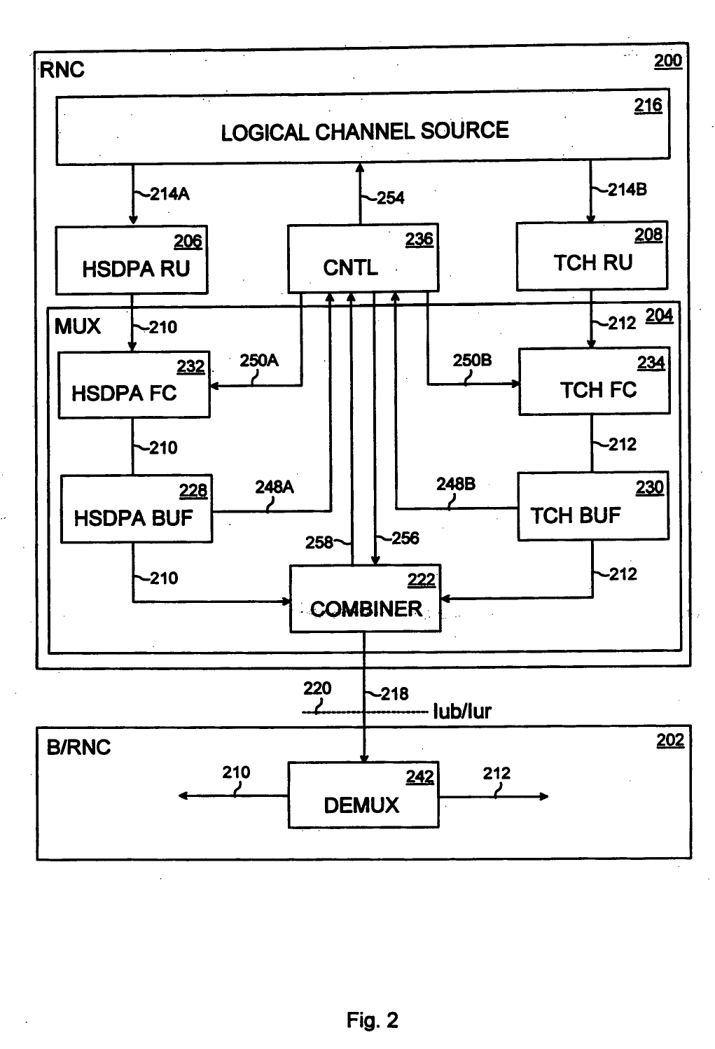

With reference to FIG. 2, a logical channel data stream 214A, 214B is generated in a logical channel source 216. The logical channel data stream 214A, 214B may include, for example, data of dedicated logical channels, such as the dedicated logical control channel (DCCH) and the dedicated logical traffic channel (DTCH) of the UMTS.

At least a portion of the logical channel data stream 214A is inputted into an HSDPA router unit (HSDPA RU) 206, which forms an HSDPA data stream 210 from the at least a portion of the logical channel data stream 214A.

The HSDPA data stream 210 typically includes HSDPA data packets associated with HSDPA downlink channels 118A, 118B. The HSDPA data stream 210 is typically formed in a MAC-d (Medium Access Control) entity and directed at a MAC-hs entity directly or via a MAC-sh entity. The HSDPA data stream 210 may also be referred to as MAC-d flows.

The HSDPA router unit 206 may perform tasks such as multiplexing several logical channels onto one MAC-d flow.

At least a portion of the logical channel data stream 214B is inputted into a transport channel mapping unit (TCH MU) 208, which forms a transport channel data stream 212 from the at least a portion of the logical channel data stream 214B.

The transport channel data stream 212 typically includes downlink data packets of transport channels, such as a dedicated transport channel (DCH). The downlink data packets may include real-time data, such as voice data, and non-real time data, such as video data.

The transport channel mapping unit 208 may perform tasks, such as switching the transport channel type, ciphering, multiplexing of a plurality logical channels onto a single transport channel, downlink scheduling of the downlink data packets, and priority handling of the downlink data packets.

In terms of the layer structure adopted in the UMTS specification, the HSDPA data stream 210 and the transport channel data stream 212 are typically carried by AAL2 connections (AAL2, asynchronous transfer mode (ATM) adaptation layer type 2), which provide variable bit rate, connection-oriented, and time-dependent data traffic for delay-sensitive applications, such as packet voice and variable-bit rate video transmission.

In this context, an AAL2 connection associated with the HSDPA data stream 210 may be referred to as a high-speed downlink packet access asynchronous transfer mode adaptation layer type 2 (HSDPA AAL2) connection. Furthermore, an AAL2 connection associated with the transport channel data stream 212 may be referred to as a transport channel asynchronous transfer mode adaptation layer type 2 (TCH AAL2) connection. The AAL2 layer and its prior art characteristics are defined in the 3GPP (3^{rd} Generation Partnership Project) specification, for example.

The HSDPA router unit 206 and/or the transport channel mapping unit 208 may be implemented with a digital signal processor and software. Applications may exist, where the at least a portion of the HSDPA router unit 206 and/or the transport channel mapping unit 208 is implemented with ASICs (Application Specific Integrated Circuit) and/or FPGAs (Field Programmable Gate Array).

The HSDPA data stream 210 and the transport channel data stream 212 are inputted into a multiplexing unit 204, which multiplexes the transport channel data stream 212 and the HSDPA data stream 210 into a virtual channel 218. The virtual channel 218 acts as a transport mechanism over an interface 220 between the radio network controller 200 and another network element 202.

In terms of AAL2 connections and the associated terminology, the multiplexing unit 204 multiplexes at least one HSDPA AAL2 connection and at least one TCH AAL2 connection into a virtual channel connection (VCC).

FIG. 2 further shows another network element 202 connected to the network controller 200.

In an embodiment of the invention, the virtual channel 218 provides a communication link over an lub interface 200 between the radio network controller 200 and the other network element 202. In such a case, the other network element 202 is a node B.

In another embodiment of the invention, the virtual channel 218 provides a communication link over an Iur interface 200 between the radio network controller 200 and the other network element 202. In such a case, the other network element 202 is a radio network controller.

The virtual channel 218 may carry, for example, a virtual channel connection (VCC), which typically provides for the transport of ATM cells among ATM active elements. The virtual channel 218 typically has a limited bandwidth, which results in a limited data transfer capacity.

The multiplexing unit 204 typically includes a combiner 222, which uses the HSDPA data stream 210 and the transport channel data stream 212 as input and arranges portions of the HSDPA data stream 210 and portions of the transport channel data stream 212 onto a single bearer. A portion of the HSDPA data stream 210 may be, for example, a MAC-d flow associated with a single HSDPA downlink channel 118A, 118B.

The combiner 222 may be implemented with a digital signal processor and software. Applications may exist where the combiner 222 is implemented with ASIC and/or FPGA technology.

In an embodiment of the invention, the radio network controller 200 includes adjusting means, such as an HSDPA data stream flow controller (HSDPA FC) 232 and/or a transport channel data stream flow controller (TCH FC) 234, which adjust the multiplexing rate of the transport channel data stream 212 and the multiplexing rate of the HSDPA data stream 210 in order to optimize the data transport efficiency of the virtual channel 218. A multiplexing rate typically indicates a rate at which bits of a data flow are inputted into the virtual channel 218.

In terms of the AAL2 connections, the adjusting means adjust the multiplexing rate of the at least one TCH AAL2 connection and the multiplexing rate of the at least one HSDPA AAL2 connection in order to optimize the data transport efficiency of the virtual channel connection.

The HSDPA flow controller 232 may control the HSDPA data stream 210, for example, by scheduling data packets of the HSDPA data stream 210 such that a desired multiplexing rate is obtained in the combiner 222.

The transport channel flow controller 232 may control the transport channel data stream 212, for example, by scheduling data packets of the transport channel data stream 212 such that a desired multiplexing rate is obtained in the combiner 222.

The HSDPA data stream flow controller 232 and/or the transport channel data stream flow controller 234 may receive instruction signals 250A and 250B, respectively, from a control unit (CNTL) 236. The HSDPA data stream flow controller 232 and/or a transport channel data stream flow controller 234 control, for example, the bit rate of the HSDPA data stream 210 and the bit rate of the transport channel data stream 212 according to the instruction signals 250A and 250B, respectively.

An instruction signal 250A, 250B may be formed in the control unit 236 based on a priori information on the available capacity of the virtual channel 218 and/or information on the multiplexing process in the combiner 222. The flow of the HSDPA data stream 210 and/or the flow of the transport channel data stream 212 may be adjusted such that a predefined amount of the capacity of the virtual channel 218 is in use. The information on the multiplexing process may be delivered to the control unit 236 by a combiner status signal 258 generated in the combiner 222.

The multiplexing rate of the transport channel data stream 212 and the multiplexing rate of the HSDPA data stream 210 may also be adjusted by the combiner 222 based on, for example, a control signal 256 generated in the control unit 236. In such a case, the control signal 256 may include the multiplexing rates.

The HSDPA flow controller 232 and the transport channel flow controller 234 may be implemented with a digital signal processor and software, for example.

The control unit 236 may be implemented, for example, with a digital signal processor and software.

In an embodiment of the invention, the multiplexing rate of the transport channel data stream 212 and the multiplexing rate of the HSDPA data stream 210 are adjusted according to the priority of the HSDPA data stream 210 and the priority of the transport channel data stream 212.

In an embodiment, the transport channel data stream 212 is prioritized over the HSDPA data stream 210. In such a case, the transport channel data stream 212 may flow freely, whereas the flow of the HSDPA data stream 210 is adjusted to optimize the data transport efficiency of the virtual channel 218. With such an arrangement, the HSDPA data stream 210 is transported in a best-effort manner while reducing the waste of the capacity of the virtual channel 218.

A variety of priority classes may be used. The transport channel data stream 212 may be assigned the highest priority class. The HSDPA data stream may 210 may be assigned the lowest priority class. Different TCH AAL2 connections may further be assigned different priority classes. Furthermore, different HSDPA AAL2 connections may be assigned different priority classes.

The priorities assigned to the HSDPA AAL2 connections and the priorities assigned to the TCH AAL connections may have an impact on the routing of the AAL2 connections, i.e. on the unit 206, 208 from which the AAL2 connections originate. If there are internal priorities between the AAL2 connections within a group of the TCH AAL2 connections and between the AAL2 connections within a group of HSDPA AAL2 connections, each AAL2 connection may be assigned a priority during an AAL2 connection setup. The priority information may then be inputted into the multiplexing unit 204.

In an embodiment of the invention, the HSDPA routing unit 206 and the TCH mapping unit 208 include sub-units with sub-unit-specific priority. In such a case, the multiplexing unit 204 may deduce the priority associated with an AAL2 connection on the basis on the sub-unit from which the AAL2 connection originates.

In an embodiment of the invention, the radio network controller 200 includes an HSDPA buffer (HSDPA BUF) 228 connected to the combiner 222. The HSDPA buffer 228 buffers at least a portion of the HSDPA data stream 210 and delivers the HSDPA data stream to the combiner 222.

The control unit 236 may monitor the filling degree of the HSDPA buffer 228 by receiving, for example, an HSDPA buffer control signal 248A from the HSDPA buffer 228. The filling degree may indicate the fullness of the registers of the HSDPA buffer 228.

The HSDPA buffer 228 may be divided into sub-buffers, each of which buffers a single MAC-d flow comprised by the HSDPA data stream 210.

The radio network controller 200 may further include a transport channel buffer (TCH BUF) 230 connected to the combiner 222. The transport channel buffer 230 buffers at least a portion of the transport channel data stream 212 and delivers the transport channel data stream 212 to the combiner 222.

The control unit 236 may monitor the filling degree of the transport channel buffer 230 by receiving, for example, a transport channel buffer control signal 248B from the transport channel buffer 230. The filling degree may indicate the fullness of the registers of the transport channel buffer 230.

In an embodiment of the invention, the adjusting means, such as the HSDPA flow controller 232, transport channel flow controller 234, and the control unit 236, adjusts the multiplexing rate of the transport channel data stream 212 and the multiplexing rate of the HSDPA data stream 210 according to the filling degree of the transport channel buffer 230. For example, if the transport channel data stream 212 and the HSDPA data stream 210 are assigned a high priority and a low priority, respectively, a low filling degree of the transport channel buffer 230 may be required to schedule the data packets of the HSDPA data stream 210 into the virtual channel 218. In some cases, an empty transport channel buffer 230 is required to schedule the HSDPA data packets into the virtual channel 218.

In an embodiment of the invention, the logical channel source 216 controls the logical channel data stream 214A associated with the HSDPA data stream 210 according to the filling degree of the HSDPA buffer 228. Furthermore, the filling degree of the transport channel buffer 230 may be used. The control unit 236, for example, may send a control signal 254 to the logical channel source 216 in order to instruct the logical channel source 216 to adjust the output data rate such that the filling degree of the HSDPA buffer 228 and that of the transport buffer 230 remain within predefined limits. With such an arrangement, the virtual channel 218 may be protected from overload and packet losses may be prevented.

In an embodiment of the invention, the other network element 202 includes a de-multiplexing unit 242 for de-multiplexing the transport channel data stream 212 and the HSDPA data stream 210 from the virtual channel 218. The HSDPA data stream 210 may be directed at a MAC-hs layer directly or via a MAC-sh layer. The de-multiplexing unit 242 may be implemented with a digital signal processor and software, for example.

With reference to FIG. 3, various schemes for allocating the capacity of the virtual channel connection are illustrated. The vertical axis 300 shows the capacity in arbitrary units. The bars 304A, 304B, 304C with solid lines show the share of the TCH AAL2 connections of the overall capacity 302 of the virtual channel connection. The bars 306A, 306B, 306C with dashed lines show the share of the HSDPA AAL2 connections of the overall capacity 302 of the virtual channel connection.

In an embodiment of the invention, a portion 310 of the capacity of the virtual channel connection is reserved for the HSDPA AAL2 connections. Furthermore, each AAL2 connection may be set up with a minimum capacity, which is always available for the HSDPA AAL2 connections. Another portion 308 may be reserved for the TCH AAL connections, for example.

In an embodiment of the invention, a zero capacity is reserved for an HSDPA AAL2 connection. In such a case, the HSDPA AAL2 connection is allocated capacity depending on capacity available.

In an embodiment of the invention, the overall capacity 302 is divided into a first portion 314 controlled by the AAL2 connection admission control (CAC), and a second portion 312 not controlled by the AAL2 CAC. The second portion 312 provides a buffer capacity, which may be available for new AAL2 connections, including the HSDPA AAL2 connections. The buffer capacity may be allocated to unshaped HSDPA AAL2 connections depending, for example, on the capacity requirements of the TCH AAL2 connections.

The connection admission control ensures that admitted AAL2 connections can be transported over the virtual channel connection without service degradation, such as losses and delays. Therefore, for each AAL2 connection, the maximum required capacity may be specified. However, the actual amount of capacity used by an AAL2 connection could be less than the maximum capacity. Usually, a traffic source provides traffic shaping to ensure that the traffic of an AAL2 connection does not exceed the maximum specified capacity needs per an AAL2 connection. Apart from those two aspects, the AAL2 connection's traffic parameters, such as a peak data rate, are not used. For the HSDPA AAL2 connections, traffic shaping may not be used, and the upper capacity limit is set by the virtual channel connection capacity. Due to the prioritization, the upper limit for the HSDPA AAL2 connections equals the virtual channel connection capacity minus the bandwidth used by the TCH AAL2 connections.

Capacity may be reserved with a digital signal processor and software, for example, in the control unit 236.

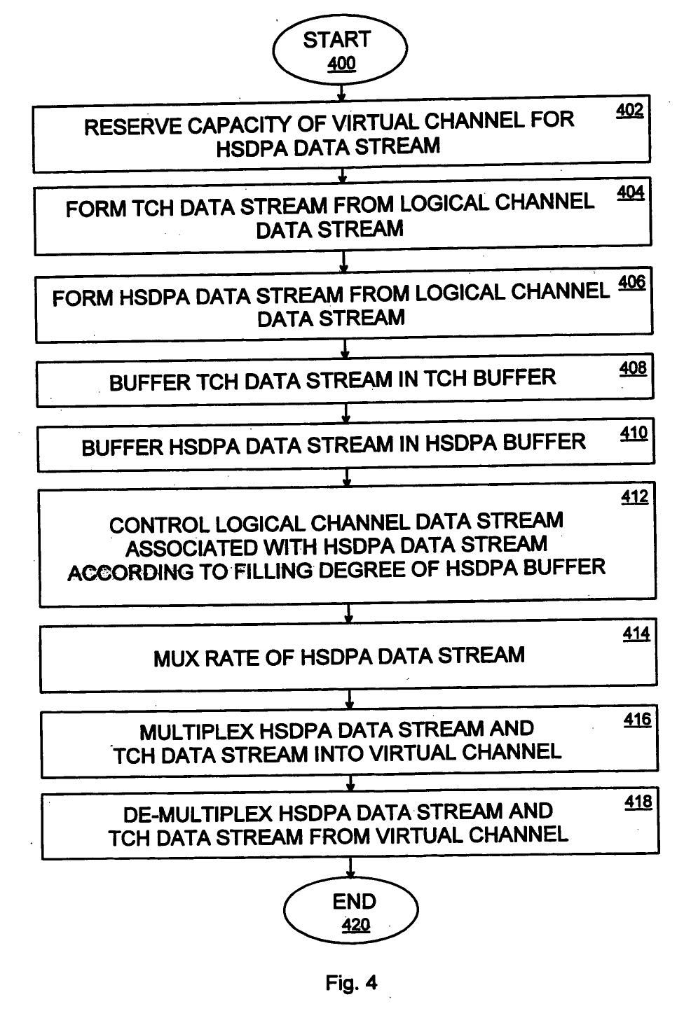

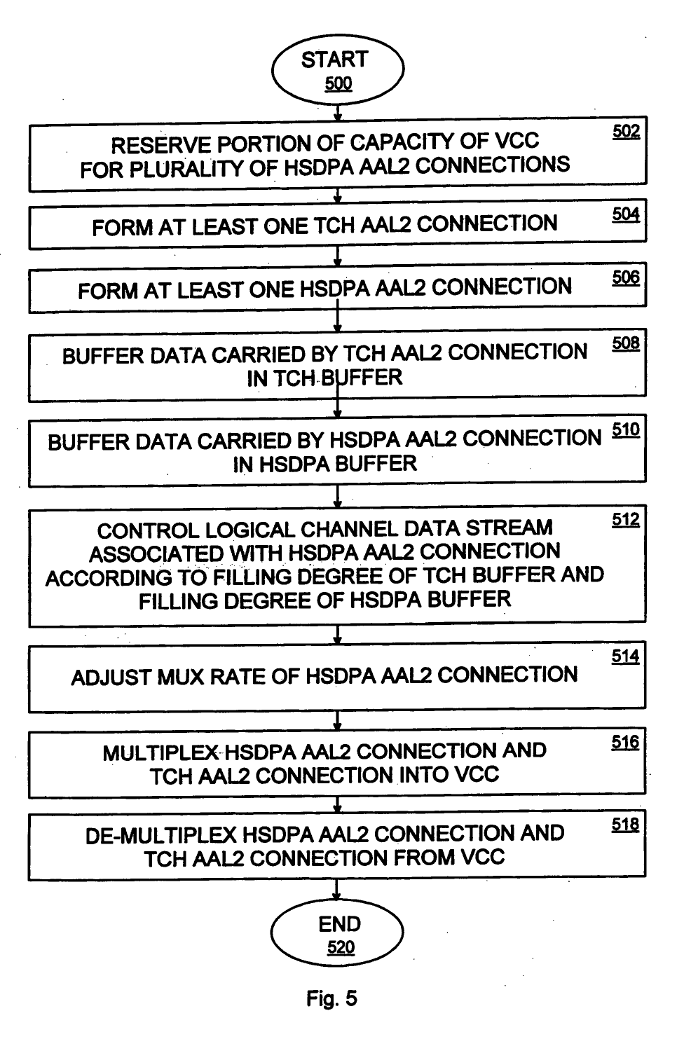

With reference to FIG. 4 and 5, examples of a methodology according to embodiments of the invention are illustrated with flow charts.

In 400 in FIG. 4, the method is started.

In 402, a portion of the capacity of the virtual channel 218 is reserved for the HSDPA data stream 210.

In 404, a transport channel data stream 212 is formed from at least a portion of a logical channel data stream 214B.

In 406, a HSDPA data stream 210 is formed from at least a portion of a logical channel data stream 214A.

In 408, at least a portion of the transport channel data stream 212 is buffered in at least one transport channel buffer 230.

In 410, at least a portion of the HSDPA data stream 210 is buffered in at least one HSDPA buffer 228.

In 412, the logical channel data stream 214A associated with the HSDPA data stream 210 is controlled according to the filling degree of the at least one HSDPA buffer 228.

In 414, the multiplexing rate of the transport channel data stream 212 and the multiplexing rate of the HSDPA data stream 210 are adjusted.

In an embodiment of the invention, the multiplexing rate of the transport channel data stream 212 and the multiplexing rate of the HSDPA data stream 210 are adjusted in order to optimize the data transport efficiency of the virtual channel 218.

In an embodiment of the invention, the multiplexing rate of the HSDPA data stream 210 is adjusted according to the filling degree of the at least one HSDPA buffer 228.

In an embodiment of the invention, the multiplexing rate of the transport channel data stream 212 and the multiplexing rate of the HSDPA data stream 210 are adjusted according to the priority of the HSDPA data stream 210 and the priority of the transport channel data stream 212.

In 416, at least a portion of the transport channel data stream 212 and at least a portion of the HSDPA data stream 210 are multiplexed into a virtual channel 218.

In 418, the transport channel data stream 212 and the HSDPA data stream 210 are de-multiplexed from the virtual channel 218.

in 420, the method ends.

In 500 in FIG. 5, the method starts.

In 502, a portion of the capacity of the virtual channel connection is reserved for a plurality of HSDPA AAL2 connections.

In 504, at least one TCH AAL2 connection is formed.

In 506, at least one HSDPA AAL2 connection is formed.

In 508, data carried by the at least one TCH AAL2 connection is buffered in at least one TCH buffer 230.

In 510, data carried by the at least one HSDPA AAL2 connection is buffered in at least one HSDPA buffer 228.

In 512, the logical channel data stream 214A associated with the HSDPA AAL2 connection is controlled according to the filling degree of the at least one HSDPA buffer 228.

In 514, the multiplexing rate of the at least one TCH AAL2 connection and the multiplexing rate of the at least one HSDPA AAL2 connection are adjusted.

In an embodiment of the invention, the multiplexing rate of the at least one TCH AAL2 connection and the multiplexing rate of the at least one HSDPA AAL2 connection are adjusted in order to optimize the data transport efficiency of the virtual channel connection.

In an embodiment of the invention, the multiplexing rate of the at least one TCH AAL2 connection and the multiplexing rate of the at least one HSDPA AAL2 connection are adjusted according to the priority of the at least one TCH AAL2 connection and the priority of the at least one HSDPA AAL2 connection.

In an embodiment of the invention, the multiplexing rate of the at least one HSDPA AAL2 connection is adjusted according to the filling degree of the at least one TCH buffer 230.

In 516, the at least one HSDPA AAL2 connection and the at least one TCH AAL2 connection are multiplexed into a virtual channel connection.

In 518, the at least one TCH AAL2 connection and the at least one HSDPA AAL2 connection are multiplexed from the virtual channel connection.

In 520, the method ends.

In an aspect, the invention provides a computer program embodied on a computer readable medium, such as a program storage medium, a record medium, a computer readable memory, a computer readable software distribution package, a computer readable signal, a computer readable telecommunications signal, and a computer readable compressed software package.

The computer program includes instructions for executing a computer process, the steps and embodiments of which are shown in FIG. 5.

The computer program may be stored in the memory means of the radio network controller 200 and executed in the digital computer of the radio network controller 200.

Even though the invention has been described above with reference to an example according to the accompanying drawings, it is clear that the invention is not restricted thereto but it can be modified in several ways within the scope of the appended claims.

1. A data transport method for a Universal Mobile Telecommunications System (UMTS) network, the method comprising:
forming a transport channel data stream from at least a portion of a logical channel data stream;
forming a high-speed downlink packet access data stream from at least a portion of a logical channel data stream; and
multiplexing at least a portion of the transport channel data stream and at least a portion of the high-speed downlink packet access data stream into a virtual channel.

2. The method of claim 1, further comprising adjusting a multiplexing rate of the transport channel data stream and a multiplexing rate of the high-speed downlink packet access data stream in order to optimize a data transport efficiency of the virtual channel.

3. The method of claim 1, further comprising adjusting a multiplexing rate of the transport channel data stream and a multiplexing rate of the high-speed downlink packet access data stream according to a priority of the high-speed downlink packet access data stream and the priority of the transport channel data stream.

4. The method of claim 1, further comprising:
buffering the at least a portion of the transport channel data stream in at least one transport channel buffer; and
adjusting a multiplexing rate of the high-speed downlink packet access data stream according to a filling degree of the at least one transport channel buffer.

5. The method of claim 1, further comprising:
buffering the at least a portion of the high-speed downlink packet access data stream in at least one high-speed downlink packet access buffer; and
controlling the logical channel data stream associated with the high-speed downlink packet access data stream according to a filling degree of the at least one high-speed downlink packet access buffer.

6. The method of claim 1, further comprising reserving a portion of a capacity of the virtual channel for the high-speed downlink packet access data stream.

7. The method of claim 1, further comprising de-multiplexing the transport channel data stream and the high-speed downlink packet access data stream from the virtual channel.

8. A data transport method for a Universal Mobile Telecommunications System (UMTS) network, the method comprising:
forming at least one transport channel asynchronous transfer mode adaptation layer 2 connection;
forming at least one high-speed downlink packet access asynchronous transfer mode adaptation layer 2 connection; and
multiplexing the at least one high-speed downlink packet access asynchronous transfer mode adaptation layer 2 connection and the at least one transport channel asynchronous transfer mode adaptation layer 2 connection into a virtual channel connection.

9. The method of claim 8, further comprising adjusting a multiplexing rate of the at least one transport channel asynchronous transfer mode adaptation layer 2 connection and a multiplexing rate of the at least one high-speed downlink packet access asynchronous transfer mode adaptation layer 2 connection in order to optimize a data transport efficiency of the virtual channel connection.

10. The method of claim 8, further comprising adjusting a multiplexing rate of the at least one transport channel asynchronous transfer mode adaptation layer 2 connection and a multiplexing rate of the high-speed downlink packet access asynchronous transfer mode adaptation layer 2 connection according to a priority of the at least one transport channel asynchronous transfer mode adaptation layer 2 connection and a priority of the at least one high-speed downlink packet access asynchronous transfer mode adaptation layer 2 connection.

11. The method of claim 8, further comprising:
buffering data carried by the at least one transport channel asynchronous transfer mode adaptation layer 2 connection in at least one trans-port channel buffer; and
adjusting a multiplexing rate of the high-speed downlink packet access asynchronous transfer mode adaptation layer 2 connection according to a filling degree of the at least one transport channel buffer.

12. The method of claim 8, further comprising:
buffering data carried by the at least one high-speed downlink packet access asynchronous transfer mode adaptation layer 2 connection in at least one high-speed downlink packet access buffer; and
controlling a logical channel data stream associated with the at least one high-speed downlink packet access asynchronous transfer mode adaptation layer 2 connection according to a filling degree of the at least one high-speed downlink packet access buffer.

13. The method of claim 8, further comprising reserving a portion of the capacity of the virtual channel connection for a plurality of high-speed downlink packet access asynchronous transfer mode adaptation layer 2 connections.

14. The method of claim 8, further comprising de-multiplexing the at least one transport channel asynchronous transfer mode adaptation layer 2 connection and the at least one high-speed downlink packet access asynchronous transfer mode adaptation layer 2 connection from the virtual channel connection.

15. A network element of a Universal Mobile Telecommunications System (UMTS) network, the network element comprising:
first forming means for forming a transport channel data stream from at least a portion of a logical channel data stream;
second forming means for forming a high-speed downlink packet access data stream from at least a portion of a logical channel data stream; and
multiplexing means for multiplexing the transport channel data stream and the high-speed downlink packet access data stream into a virtual channel.

16. The network element of claim 15, further comprising first adjusting means for adjusting a multiplexing rate of the transport channel data stream and a multiplexing rate of the high-speed downlink packet access data stream in order to optimize a data transport efficiency of the virtual channel.

17. The network element of claim 15, further comprising second adjusting means for adjusting a multiplexing rate of the transport channel data stream and a multiplexing rate of the high-speed downlink packet access data stream according to a priority of the high-speed downlink packet access data stream and the priority of the transport channel data stream.

18. The network element of claim 15, further comprising:
first buffering means for buffering at least a portion of the transport channel data stream; and
third adjusting means for adjusting a multiplexing rate of the high-speed downlink packet access data stream according to a filling degree of the first buffering means.

19. The network element of claim 15, further comprising:
second buffering means for buffering at least a portion of the high-speed downlink packet access data stream; and
controlling means for controlling the logical channel data stream associated with the high-speed downlink packet access data stream according to a filling degree of the second buffering means.

20. The network element of claim 15, further comprising reserving means for reserving a portion of the capacity of the virtual channel for the transport channel data stream to the high-speed downlink packet access data stream.

21. A radio network controller of a Universal Mobile Telecommunications System (UMTS) network, the radio network controller comprising:
first forming means for forming at least one transport channel asynchronous transfer mode adaptation layer 2 connection;
second forming means for forming at least one high-speed downlink packet access asynchronous transfer mode adaptation layer 2 connection; and
multiplexing means for multiplexing the at least one high-speed downlink packet access asynchronous transfer mode adaptation layer 2 connection and the at least one transport channel asynchronous transfer mode adaptation layer 2 connection into a virtual channel connection.

22. The radio network controller of claim 21, further comprising first adjusting means for adjusting a multiplexing rate of the at least one transport channel asynchronous transfer mode adaptation layer 2 connection and the multiplexing rate of the at least one high-speed downlink packet access asynchronous transfer mode adaptation layer 2 connection in order to optimize a data transport efficiency of the virtual channel connection.

23. The radio network controller of claim 21, further comprising second adjusting means for adjusting a multiplexing rate of the at least one transport channel asynchronous transfer mode adaptation layer 2 connection and a multiplexing rate of the at least one high-speed downlink packet access asynchronous transfer mode adaptation layer 2 connection according to a priority of the at least one transport channel asynchronous transfer mode adaptation layer 2 connection and the priority of the at least one high-speed downlink packet access asynchronous transfer mode adaptation layer 2 connection.

24. The radio network controller of claim 21, further comprising:
first buffering means for buffering data carried by the at least one transport channel asynchronous transfer mode adaptation layer 2 connection; and
third adjusting means for adjusting a multiplexing rate of the at least one high-speed downlink packet access asynchronous transfer mode adaptation layer 2 connection according to a filling degree of the first buffering means.

25. The radio network controller of claim 21, further comprising:
second buffering means for buffering data carried by the at least one high-speed downlink packet access asynchronous transfer mode adaptation layer 2 connection; and
controlling means for controlling a logical channel data stream associated with the at least one high-speed downlink packet access asynchronous transfer mode adaptation layer 2 connection according to a filling degree of the second buffering means.

26. The radio network controller of claim 21, further comprising reserving means for reserving a portion of the capacity of the virtual channel connection for a plurality of high-speed downlink packet access asynchronous transfer mode adaptation layer 2 connections.

27. A computer program embodied on a computer readable medium, for executing a computer process for data transport in a Universal Mobile Telecommunications System (UMTS) network, the computer process including steps, the steps comprising:
forming at least one transport channel asynchronous transfer mode adaptation layer 2 connection;
forming at least one high-speed downlink packet access asynchronous transfer mode adaptation layer 2 connection; and
multiplexing the at least one high-speed downlink packet access asynchronous transfer mode adaptation layer 2 connection and the at least one transport channel asynchronous transfer mode adaptation layer 2 connection into a virtual channel connection.

28. The computer program of claim 27, wherein the computer process further comprises adjusting a multiplexing rate of the at least one transport channel asynchronous transfer mode adaptation layer 2 connection and a multiplexing rate of the at least one high-speed downlink packet access asynchronous transfer mode adaptation layer 2 connection in order to optimize data transport efficiency of the virtual channel connection.

29. The computer program of claim 27, wherein the computer process further comprises adjusting a multiplexing rate of the at least one transport channel asynchronous transfer mode adaptation layer 2 connection and the multiplexing rate of the at least one high-speed downlink packet access asynchronous transfer mode adaptation layer 2 connection according to a priority of the at least one transport channel asynchronous transfer mode adaptation layer 2 connection and the priority of the at least one high-speed downlink packet access asynchronous transfer mode adaptation layer 2 connection.

30. The computer program of claim 27, wherein the computer process further comprises:
buffering data carried by the at least one transport channel asynchronous transfer mode adaptation layer 2 connection in at least one transport channel buffer; and
adjusting a multiplexing rate of the at least one high-speed downlink packet access asynchronous transfer mode adaptation layer 2 connection according to a filling degree of the at least one transport channel buffer.

31. The computer program of claim 27, wherein the computer process further comprises:
buffering data carried by the at least one high-speed downlink packet access asynchronous transfer mode adaptation layer 2 connection in at least one high-speed downlink packet access buffer; and
controlling a logical channel data stream associated with the at least one high-speed downlink packet access asynchronous transfer mode adaptation layer 2 connection according to a filling degree of the at least one high-speed downlink packet access buffer.

32. The computer program of claim 27, wherein the computer process further comprises reserving a portion of the capacity of the virtual channel connection for a plurality of high-speed downlink packet access asynchronous transfer mode adaptation layer 2 connections.
